(19) United States
(12) Patent Application Publication
(10) Pub. No.: US 2016/0207565 A1
(43) Pub. Date: Jul. 21, 2016

(54) DOUBLE-PINION STEERING MECHANISM HAVING A HOLLOW SHAFT MOTOR

(71) Applicant: THYSSENKRUPP PRESTA AG, Eschen (LI)

(72) Inventors: Aksel Maier, Pluderhausen (DE); Anatoli Schroder, Ludwigsburg (DE); Christine Goldberg, Deizisau (DE); Kai Vohwinkel, Reichenbach (DE)

(73) Assignee: THYSSENKRUPP PRESTA AG, Eschen (LI)

(21) Appl. No.: 14/899,091

(22) PCT Filed: Jun. 13, 2014
(86) PCT No.: PCT/EP2014/062322

§ 371 Date: Apr. 7, 2016

(30) Foreign Application Priority Data
Jun. 21, 2013 (DE) 10 2013 010 362.2

(51) Int. Cl. B62D 5/04; B62D 3/12

(52) U.S. Cl. CPC B62D 5/0421; B62D 5/0442; B62D 3/126

(57) ABSTRACT

A steering gear mechanism for motor vehicles may include a steering system housing in which a toothed rack is mounted and displaceable along a longitudinal axis. The toothed rack may be connected to steerable wheels of a motor vehicle and configured to pivot the steerable wheels. The toothed rack can include a first toothed segment that meshes with a first pinion of a pinion shaft, with the pinion shaft being connected to a steering wheel via a steering shaft. The toothed rack may further include a second toothed segment that is situated opposite the first toothed segment with respect to the longitudinal axis and engages with a second pinion. Further, an electric motor can drive the first pinion in a first direction, which by way of direct or indirect coupling causes the second pinion to rotate in a second direction opposite the first direction. The electric motor may in some cases be in the form of a hollow-shaft motor that at least partially surrounds the input shaft and/or the pinion shaft.

The present invention relates to a steering gear mechanism for motor vehicles, having the features of the preamble of claim 1.

For large and heavy vehicles in the so-called medium-size category and in the luxury car category and for all-terrain vehicles, a structural form of the electrically assisted steering gear mechanism for motor vehicles is preferred in which the assistance force is introduced into the toothed rack by way of a second toothing. Steering gear mechanisms are known in which the servo drive acts on the toothed rack by way of a second steering pinion and a second toothing. Such steering gear mechanisms are presented in the laid-open specifications DE 10 2005 022 867 A1, DE 10 2007 004 218 A1 and WO 2006/138209 A2. Said steering gear mechanisms have a relatively large structural volume as the servo drive is provided separately adjacent to the meshing engagement of the steering pinion and toothed rack. Furthermore, the guidance of the toothed rack in the region of the steering pinion must be kept free from play by way of a thrust piece. This bearing arrangement involves production costs and constitutes a possible source of noise in practice, which is undesirable.

DE 10 2010 027 553 A1 has disclosed a double-pinion steering gear mechanism in which the two steering pinions are arranged oppositely on the toothed rack at an angle of 90° with respect to the toothed rack. The two steering pinions are in this case mechanically positively coupled, by means of spur gears or bevel gears, for rotation in opposite directions. By means of the geometric arrangement of the pinions relative to one another, it is made possible for a cumbersome thrust piece in the hitherto known form to be omitted. At least one steering pinion is coupled to a servomotor which assists the steering action. The rotation of the steering shaft is in this case detected by a sensor. The disadvantage of the arrangement is that structural space shortages arise owing to the position of the servo drive and of the sensor.

It is therefore an object of the present invention to provide a steering gear mechanism which has compact dimensions and which nevertheless provides the steering assistance forces required for heavy motor vehicles.

Said object is achieved by a steering gear mechanism having the features of claim 1.

According to said claim, there is provided a steering gear mechanism, in particular for motor vehicles, having a steering system housing in which a toothed rack is mounted in longitudinally displaceable fashion and is connected to steerable wheels for the purposes of pivoting same, wherein the toothed rack is equipped with a first toothed segment which meshes with a first pinion of a pinion shaft, and wherein the pinion shaft is connected indirectly to a steering wheel via a steering shaft, wherein the toothed rack has a second toothed segment which is situated opposite the first toothed segment in relation to the longitudinal axis of the toothed rack, and wherein a second pinion is provided which engages with the second toothed segment, wherein an electric motor is provided which indirectly drives the first pinion which is mechanically positively coupled to the second pinion for rotation in the opposite direction, in the case of which steering gear mechanism the electric motor is in the form of a hollow-shaft motor which partially surrounds the input shaft and/or the pinion shaft at least in one section of one of these shafts. By means of this arrangement, a particularly compact structural form is possible. This applies in particular if the hollow shaft of the electric motor is arranged coaxially with respect to the input shaft.

The hollow-shaft motor preferably drives a gear mechanism shaft which is connected to the pinion shaft via a gear mechanism.

In one embodiment, a rotational angle sensor is provided on the input shaft and a rotational angle sensor is provided on the pinion shaft, such that the acting steering wheel moment and the position of the rotor can be determined.

The gear mechanism is preferably a speed-reduction gear mechanism. The motor can thus be of compact design with a high rotational speed and low torque.

It is furthermore preferably provided that the first and the second pinion are arranged obliquely on opposite sides of the toothed rack, wherein the plane spanned by the pinions intersects the longitudinal axis of the toothed rack at an angle of inclination of less than 90°. Owing to the oblique arrangement, structural space can be saved in the region of the pinions.

It is advantageous if the mechanical coupling of the two pinions is realized by way of gearwheels.

It is furthermore advantageous if the axes of rotation of the two oppositely situated pinions are arranged at an acute angle with respect to one another. It is accordingly possible for the meshing engagement of the pinion and toothed rack to be adjusted without the use of a thrust piece.

Here, it is preferably provided that the toothed segments are arranged in planes which are inclined relative to one another, correspondingly to the pinions which are arranged at an acute angle with respect to one another.

In the embodiment according to the invention, that bearing of the second pinion which is remote from the drive input advantageously has a bearing arrangement for the adjustment of the play of the meshing engagement of the pinion and toothed rack.

However, an arrangement of particularly simple construction is realized if the axes of rotation of the two oppositely situated pinions are arranged parallel to one another, as the gear mechanism elements that couple said pinions can then be designed, for example, as spur gears.

An exemplary embodiment of the present invention will be described in more detail below on the basis of the drawings, in which:

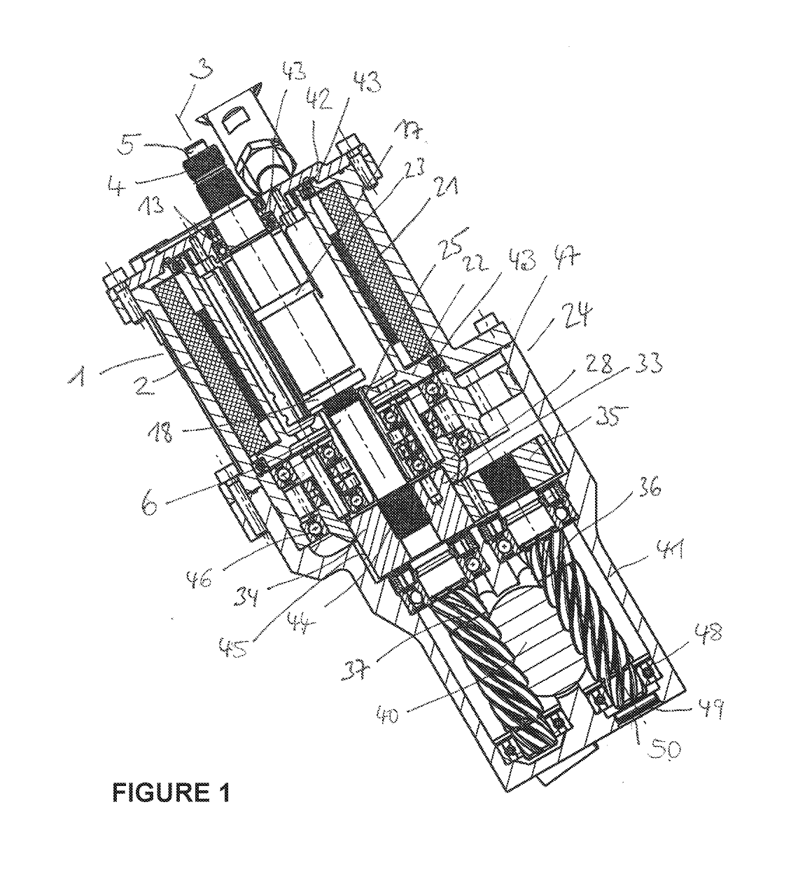

FIG. 1 shows a longitudinal section through a steering gear mechanism according to the invention with a double-pinion arrangement and hollow-shaft motor,

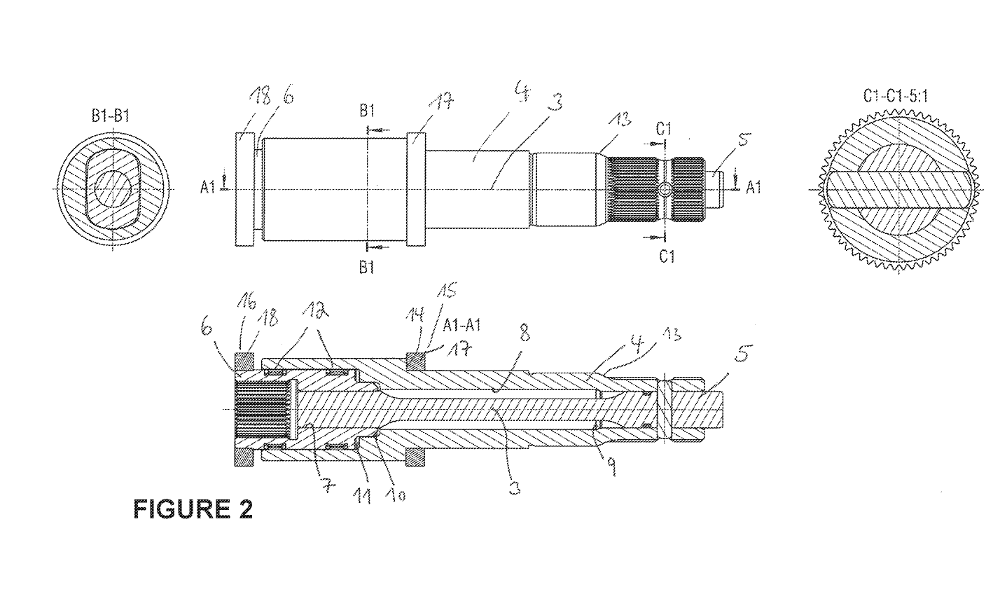

FIG. 2 shows a side view of the input shaft in conjunction with the pinion shaft, and a longitudinal section and two cross-sections of the arrangement,

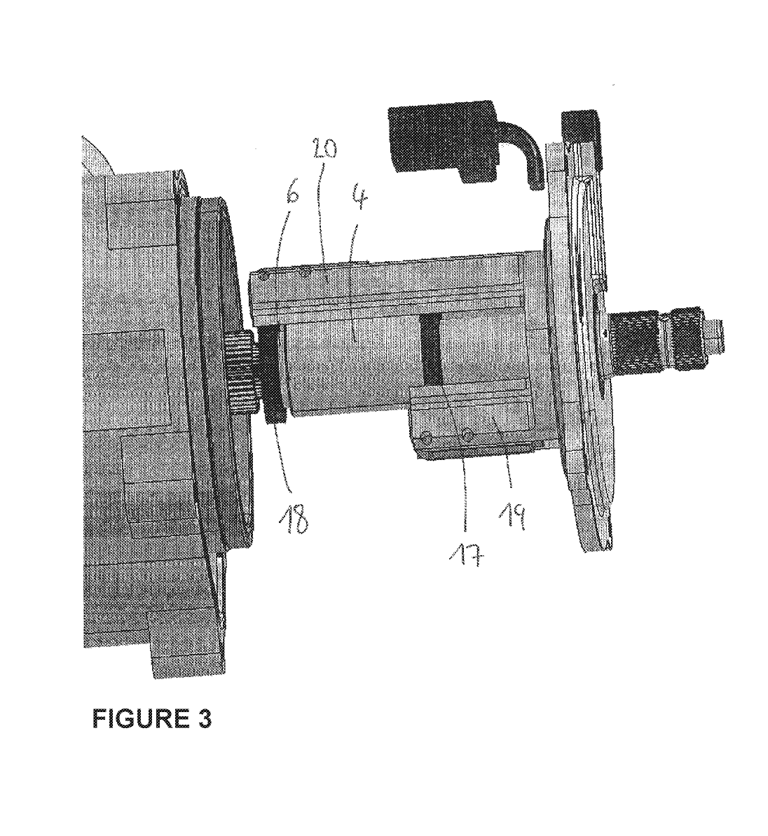

FIG. 3 is a three-dimensional illustration of the rotational angle sensors and encoder magnets on the input shaft in a pre-assembled state,

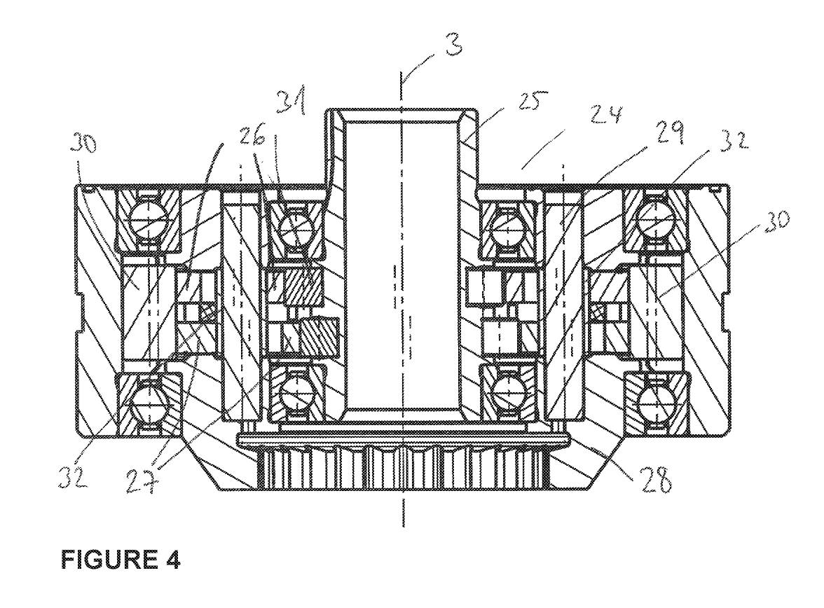

FIG. 4 shows a longitudinal section of the gear mechanism from FIG. 1,

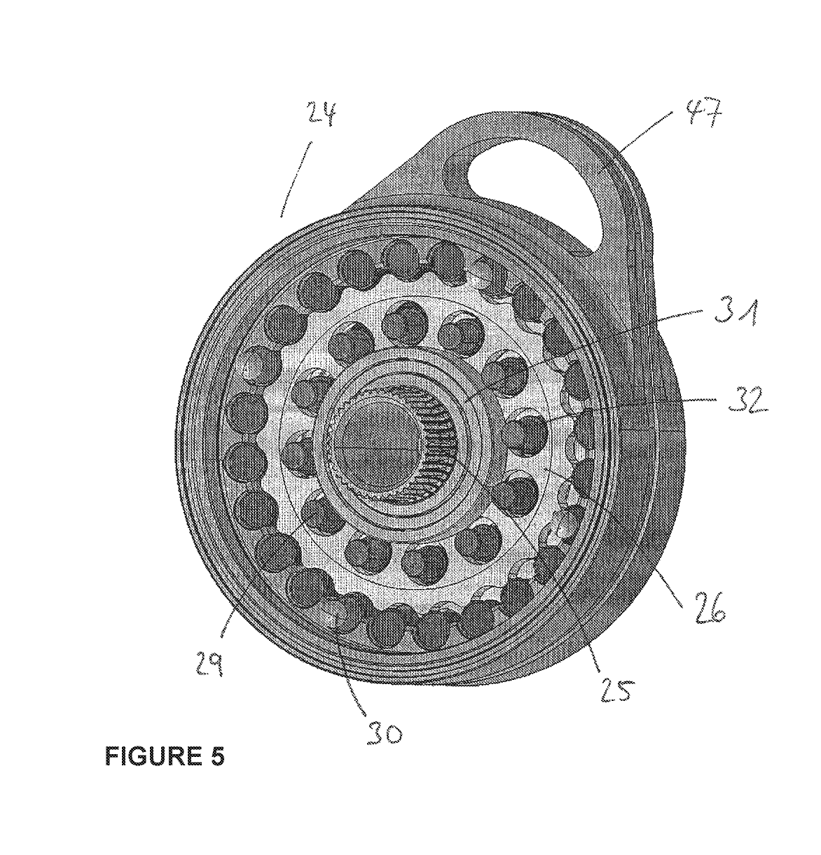

FIG. 5 is a three-dimensional illustration of the gear mechanism from FIG. 4, and

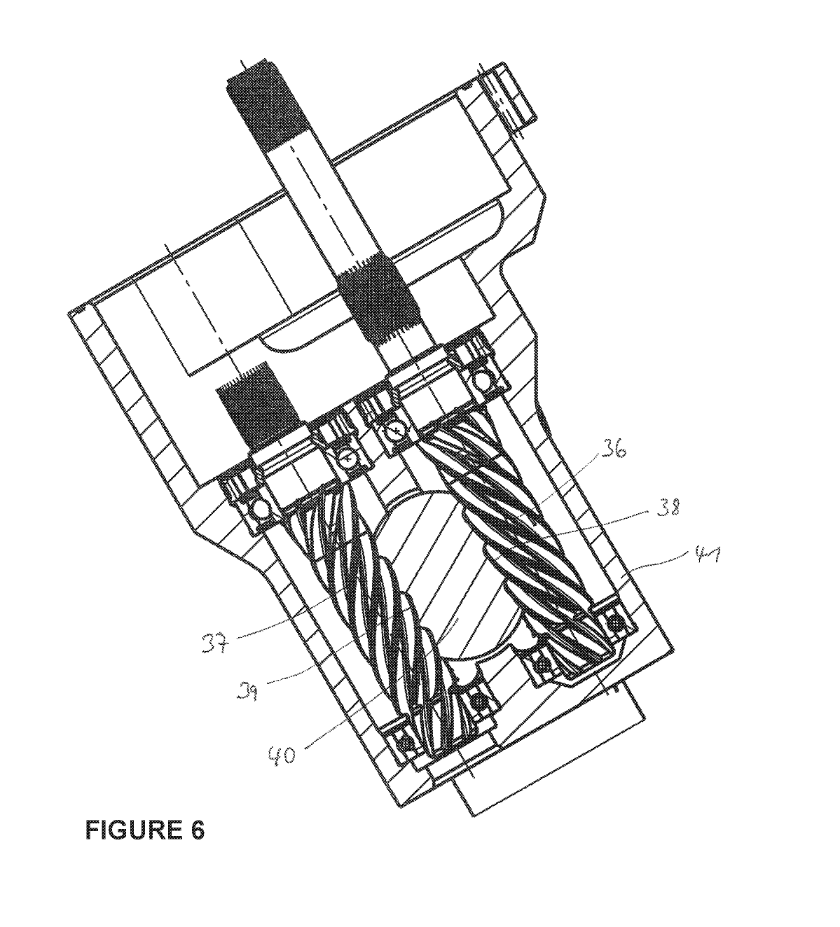

FIG. 6 shows a longitudinal section of the meshing engagement between the pinion and toothed rack.

FIG. 1 shows a hollow-shaft motor 1, situated in a motor housing 2, as a servo drive of a steering gear mechanism. The hollow-shaft motor 1 surrounds an input shaft 4 which is situated in centered fashion in the housing 2 with a longitudinal axis 3 and which is connected rotationally conjointly to the steering shaft (not illustrated here) which is connected to the steering wheel. A circular cylindrical torsion bar 5 firstly connects the input shaft 4 to a pinion shaft 6 in an axial direction, such that said input shaft and pinion shaft have a defined position relative to one another. Secondly, the torsion bar 5 effects a relative rotation between the input shaft 4 and the pinion shaft 6 in a manner dependent on the steering-wheel moment, which relative rotation is utilized for the control of the steering assistance action and the direction thereof. As shown in FIG. 2, for this purpose, the torsion bar 5 is pressed, at one end, into a circular, centered bore 7 of the pinion shaft 6. At the other end, said torsion bar is connected to the input shaft 4 by extending centrally through the input shaft 4 over the entire length and by virtue of the torsion bar and input shaft being drilled through transversely, and pinned, at the end. Here, the torsion bar 5 is narrowed in a middle section. To receive the torsion bar 5 and the pinion shaft 6, the input shaft 4 has, extending all the way through, a central recess 8 with three shoulders 9, 10 and 11. At the end remote from the pinion, in the region of the narrowing of the torsion bar 5, the recess 8 has the first shoulder 9. Up to the end close to the pinion, the recess 8 is of circular cylindrical form. The second shoulder 10 of the recess 8 serves as a collar for the pinion shaft 6 and is arranged at the end of the narrowing of the torsion bar 5. In the region of the second shoulder 10, the recess 8, and the pinion shaft 6 received therein with play, are of oval cylindrical shape. The pinion shaft 6 can thus, in the oval cylindrical recess 8, be rotated through a particular angle range until a stop serves as a mechanical concomitant-driving means. Said limitation serves to protect the torsion bar 5. The second shoulder 10 is adjoined by the third shoulder 11, in which the recess 8 is again of circular cylindrical form and the pinion shaft 6 also has a circular cross section. Here, the input shaft 4 surrounds the pinion shaft 6 with a small degree of play, wherein needle-roller bearings 12 on the pinion shaft 6 ensure that the input shaft 4 is mounted so as to be rotatable about the pinion shaft 6. The input shaft 4 has, on the outer side, a first projection 13 and a second projection 14, wherein the first projection 13 is situated in the region of the first shoulder 9 of the recess 8.

The twisting of the torsion bar 5 is detected by way of two magnetic rotational angle sensors 15, 16. The rotational angle sensors 15, 16 each have a magnet ring 17, 18, as an encoder magnet, and a sensor element 19, 20. The encoder magnets 17, 18 are preferably fixed on the input shaft 4 and the pinion shaft 6 by way of an adhesive connection. The sensor element 19, 20 may be in the form of a Hall sensor or magnetoresistive sensor. Optical sensors composed of a light-emitting component and a light-sensitive component, or strain gauges, are also conceivable. A first encoder magnet 17 is arranged on the input shaft 4 so as to be in contact with the ring-shaped collar formed by the second projection 14, and so as to be situated in front of the pinion shaft 6, and a second encoder magnet 18 is arranged on the pinion shaft 6, as is also shown in FIG. 3. The position of the magnet rings 17, 18 relative to one another during twisting of the torsion bar 5 yields, together with the known stiffness of the torsion bar 5, the steering-wheel moment.

The hollow-shaft motor 1 which comprises the input shaft 4 and pinion shaft 6 has a stator 21, a rotor 22 and a magnet 23. The input shaft 4 and the pinion shaft 6 are in this case concentrically surrounded by the rotor 22, wherein the encoder magnets 17, 18 and the sensor elements 19, 20 are arranged in between. The rotor 22 in turn is concentrically surrounded by the magnets 23 and by the stator 21. In this case, the rotor 22 is realized by way of a permanent magnet, and the static stator 21 comprises coils which, by way of an electronic circuit, are activated in temporally offset fashion in order to generate a rotating field which causes a torque to be exerted on the permanently excited rotor 22. The rotor 22 drives a gear mechanism 24 via a rotationally conjointly connected gear mechanism shaft 25. The rotor 22 is preferably connected to the gear mechanism shaft 25 by way of a spline toothing.

The gear mechanism shaft 25 is hollow and is extended through with play by the pinion shaft 6. The gear mechanism 24 is of coaxial form and is designed as a cycloid gear mechanism, as illustrated in FIG. 4 and FIG. 5. The cycloid gear mechanism 24 has two cam discs 26, 27, which are offset by 180°, a driver disk 28, driver pins 29, cylindrical pins 30, and an eccentric 31. The eccentric 31 drives the cam discs 26, 27, which are extended through by the driver pins 28 and which roll on the static cylindrical pins 30. The driver pins 29 are in this case firmly pressed into the driver disk 28 and have, at the level of the cam discs 26, 27, a bearing sleeve 32 which allows the driver disk 28 to be driven by way of the cam discs 26, 27. For every revolution of the gear mechanism shaft 25, the drive output moves onward on the static cylindrical pins 30 by one cam section. Thus, the output rotational speed of the gear mechanism shaft 25 of the gear mechanism 24 is reduced, and at the same time the torque of the driver disk 28 is increased.

As shown in FIG. 1, the driver disk 28 has a concentric bearing seat 33 for a first gearwheel 34. The first gearwheel 34 is connected rotationally conjointly to the driver disk 28 and to the pinion shaft 6 which extends through, such that the driver disk 28 indirectly drives the pinion shaft 6. Furthermore, the first gearwheel 34 meshes with a second gearwheel 35, which rotationally conjointly surrounds a second pinion 36 at an end close to the drive input. The pinion shaft 6 has, at its end remote from the drive input, a first pinion 37 which is mechanically positively coupled to the second pinion 36 by way of the two gearwheels 34, 35 at those ends of said pinions which are close to the drive input, such that said pinions rotate in opposite directions. FIG. 6 shows the pinions 37, 36, and the meshing engagement thereof with the toothed rack 40, in a detail view. The pinions 37, 36, which are oriented parallel and are spaced apart, are in meshing engagement with in each case one toothed rack segment 38, 39 on opposite sides of a toothed rack 40, wherein the toothed rack segments 38, 39 are situated opposite one another on the toothed rack 40 in relation to the longitudinal axis. The toothed rack 40 is mounted, perpendicular to the longitudinal axis 3 of the input shaft 4, in a steering system housing 41.

During the assembly process, the input shaft 4, the pinion shaft 6 and the motor 1 are inserted into the motor housing 2, wherein a cover 42 closes off the motor housing 2 in the direction of the steering shaft at the level of the first projection 13 of the input shaft 4. Here, the input shaft 4 extends through the cover 42 (see FIG. 1). Furthermore, the input shaft 4 and the rotor 22 are mounted rotatably in the motor housing 2 by way of corresponding bearings 43. The gear mechanism shaft 25 and the gear mechanism 24 are subsequently installed. Subsequently, the active first gearwheel 34 of the first pinion 37 is mounted onto a toothing 44 of the first pinion 37 with a fit, and is inserted with the outer side into the driver disk 28 in rotationally conjoint fashion. During the assembly process, the passive second gearwheel 35 is placed into play-free meshing engagement with the active first gearwheel 34. For this purpose, the passive second pinion 36 has a spline toothing and, in the direction of the drive input 1, a short cylindrical shoulder. The passive second gearwheel 35 has an inner diameter which exhibits a clearance fit with respect to the cylindrical shoulder. During the assembly process, the active gearwheel 34 is mounted onto the cylindrical part, and the passive gearwheel 35 is placed into play-free meshing engagement with the active gearwheel 34. After the play-free position has been found, the passive gearwheel 35 is pressed onto the spline toothing, wherein a positively locking connection is formed, which is configured such that the moments that arise can be transmitted. Furthermore, the two pinions 37, 36 are placed into play-free meshing engagement with the toothed rack 40, before the steering system housing 41 is brought into contact with the motor housing 2 in a longitudinal direction and connected by way of fastening means.

The steering system housing 41, connected to the motor housing 2, surrounds the gear mechanism 24 and the two pinions 37, 36 and also the toothed rack 40. In the region of the two pinions 37, 36, the steering system housing 41 is, in the longitudinal direction, formed concentrically with respect to the middle of the toothed rack. In the direction of the gear mechanism 24, the steering system housing 41 widens, wherein a first shoulder 45 is arranged at the level of the gearwheels 34, 35 and a second shoulder 46 is arranged at the level of the gear mechanism 24. Owing to the eccentric position of the toothed rack 40 in relation to the longitudinal axis 3 of the input shaft 4 respectively of the pinion shaft 6, the steering system housing 41 is, in the region of the gear mechanism 24, of rotationally non-symmetrical form about the longitudinal axis 3. Therefore, the gear mechanism 24 has, for securing it in position in the steering system housing 40, a rotation prevention means in the form of a lug 47 (see also FIG. 5). Furthermore, the pinions 37, 36 are mounted rotatably relative to the steering system housing 41 in each case at both ends. Furthermore, the steering system housing 41 has, in the region of a bearing 48, which is remote from the drive input, of the second pinion 36, an opening 50 which is closed by a closure cover 49.

The steering system housing 41 is preferably produced from aluminum or magnesium.

In a further embodiment, the second pinion has, at the bearing remote from the drive input, a bearing arrangement with two sleeves, wherein the outer sleeve forms a guide and the inner sleeve forms a sliding piece. The sliding piece is arranged so as to be displaceable along oblique guide surfaces, such that, during the displacement of the sliding piece, the pinion can be advanced toward the meshing engagement of the pinion and toothed rack. For the preload and for the adjustment of the play, a spring is provided between the sleeves and the closure cover, which is formed as an adjustment screw.

In another embodiment, it is conceivable for the coaxial gear mechanism to be in the form of a planetary gear set or some other eccentric gear mechanism or speed-reduction gear mechanism.

Furthermore, in one embodiment, it is provided that the axes of rotation of the two oppositely situated pinions are arranged at an acute angle with respect to one another, and the two toothed rack segments which are situated on the toothed rack opposite one another in relation to the longitudinal axis are arranged in planes which are inclined relative to one another, because in this way, freedom from play of the meshing engagements can be realized by virtue of the toothed rack being preloaded into the enclosed angle.

In another embodiment, it is preferably provided that the pinions have an offset relative to one another in the longitudinal direction of the toothed rack, such that structural space can be saved while maintaining the same coupling width of the pinions.

In the case of the steering gear mechanism according to the invention, if a steering movement at the steering wheel occurs, the torsion bar detects a rotation of the steering shaft relative to the pinion shaft. The signal that is thereby triggered controls the electric motor, which drives the pinion shaft via the gear mechanism which is driven by the rotor. The coaxial gear mechanism transmits the reduced output rotational speed of the gear mechanism shaft to the active first pinion.

Owing to the positive mechanical coupling of the first pinion to the second pinion, the toothed rack is driven, from opposite sides, so as to perform a longitudinal displacement, which effects a pivoting of the steered wheels. The steering assistance force generated by the servomotor is thus introduced into the toothed rack by way of two pinions.

Owing to the construction of a hollow-shaft motor which surrounds the input shaft, the servo drive is of highly compact design, as no additional space in addition to the space for the shaft is required for the drive of said shaft.

Furthermore, owing to the arrangement of the pinion in relation to the toothed rack, a thrust piece can be dispensed with.

The steering gear mechanism according to the invention has preferred compact dimensions, and nevertheless provides the steering assistance forces required for heavy motor vehicles.

### LIST OF REFERENCE NUMERALS

1 Hollow-shaft motor

2 Motor housing

3 Longitudinal axis

4 Input shaft

5 Torsion bar

6 Pinion shaft

7 Bore

8 Recess

9 First shoulder

Second shoulder

10 Third shoulder

11 Needle-roller bearing

12 First projection

14 Second projection

15 Rotational angle sensor

16 Rotational angle sensor

17 Magnet ring

18 Magnet ring

19 Sensor element

20 Sensor element

21 Stator

22 Rotor

23 Magnet

24 Gear mechanism

25 Gear mechanism shaft

26 Cam disk

27 Cam disk

28 Driver disk

29 Driver pins

30 Cylindrical pins

31 Eccentric

32 Bearing sleeve

33 Bearing seat

34 First gearwheel

35 Second gearwheel

36 Second pinion

37 First pinion

38 Toothed rack segment

39 Toothed rack segment

40 Toothed rack

41 Steering system housing

42 Cover

43 Bearing

44 Toothing

45 First shoulder

46 Second shoulder

47 Lug

48 Bearing

49 Closure cover

50 Opening

1.-10. (canceled)

11. A steering gear mechanism for motor vehicles, the steering gear mechanism comprising:
a steering system housing;
a toothed rack that is mounted in the steering system housing and is displaceable along a longitudinal axis, the toothed rack being connected to steerable wheels of the motor vehicle and configured to pivot the steerable wheels, wherein the toothed rack comprises a first toothed segment that meshes with a first pinion of a pinion shaft, wherein the pinion shaft is connected indirectly to a steering wheel via an input shaft, wherein the toothed rack comprises a second toothed segment that is positioned opposite the first toothed segment with respect to the longitudinal axis, wherein a second pinion engages with the second toothed segment; and
an electric motor that indirectly drives the first pinion in a first direction and that indirectly drives the second pinion in a second direction opposite the first direction, wherein the electric motor comprises a hollow-shaft motor that at least partially surrounds at least one of the input shaft or the pinion shaft.

12. The steering gear mechanism of claim 11 wherein the hollow-shaft motor drives a gear mechanism shaft that is connected to the pinion shaft via a gear mechanism.

13. The steering gear mechanism of claim 12 wherein the gear mechanism is a speed-reduction gear mechanism.

14. The steering gear mechanism of claim 11 further comprising:
a first rotational angle sensor disposed along the input shaft; and
a second rotational angle sensor disposed along the pinion shaft.

15. The steering gear mechanism of claim 11 wherein the first pinion and the second pinion are positioned oblique to one another and on opposite sides of the toothed rack, wherein a plane extending through the first and second pinions intersects the longitudinal axis of the toothed rack at an angle of inclination of less than 90 degrees.

16. The steering gear mechanism of claim 11 wherein gearwheels mechanically couple the first and second pinions.

17. The steering gear mechanism of claim 11 wherein an axis of rotation for the first pinion is acute with respect to an axis of rotation for the second pinion.

18. The steering gear mechanism of claim 11 wherein a plane occupied by the first toothed segment is inclined relative to a plane occupied by the second toothed segment.

19. The steering gear mechanism of claim 11 wherein an axis of rotation for the first pinion is parallel to an axis of rotation for the second pinion.

20. The steering gear mechanism of claim 11 wherein a bearing of the second pinion comprises a bearing arrangement for adjusting an amount of play of meshing engagement between the second pinion and the toothed rack.

21. A steering gear mechanism for motor vehicles, the steering gear mechanism comprising:
a steering system housing;
a toothed rack that is mounted in the steering system housing and is displaceable along a longitudinal axis, the toothed rack being connected to steerable wheels of the motor vehicle and configured to pivot the steerable wheels, wherein the toothed rack comprises a first toothed segment that meshes with a first pinion of a pinion shaft, wherein the pinion shaft is connected directly or indirectly to a steering wheel via an input shaft, wherein the toothed rack comprises a second toothed segment that is positioned opposite the first toothed segment with respect to the longitudinal axis, wherein a second pinion engages with the second toothed segment; and
an electric motor that directly or indirectly drives the first pinion in a first direction and that directly or indirectly drives the second pinion in a second direction opposite the first direction, wherein the electric motor comprises a hollow-shaft motor that at least partially surrounds at least one of the input shaft or the pinion shaft.
